(19) United States
(12) Patent Application Publication
(10) Pub. No.: US 2026/0056414 A1
(43) Pub. Date: Feb. 26, 2026

(54) HEAD-MOUNTED DEVICE FOR PROVIDING FLOATING IMAGES

(71) Applicants: CHING-TE SHIH, Kaohsiung City (TW); HAO-CHUN HSU, Taipei City (TW)

(72) Inventors: CHING-TE SHIH, Kaohsiung City (TW); HAO-CHUN HSU, Taipei City (TW)

(21) Appl. No.: 19/298,208

(22) Filed: Aug. 13, 2025

Related U.S. Application Data
(60) Provisional application No. 63/685,734, filed on Aug. 22, 2024.

(51) Int. Cl. G02B 27/01; G02B 30/56

(52) U.S. Cl. CPC G02B 27/0172; G02B 30/56

(57) ABSTRACT

A head-mounted device for providing floating images includes a head-mounted module, an image display module and an optical imaging module. The image display module is configured to be disposed inside the head-mounted module and carried by the head-mounted module. The optical imaging module is configured to be disposed inside the head-mounted module and carried by the head-mounted module. The image display module is configured to provide a plurality of first image light beams projected toward a first predetermined direction to the optical imaging module inside the head-mounted module. The optical imaging module is configured to convert the first image light beams provided by the image display module into a plurality of second image light beams that are projected toward a second predetermined direction to leave the head-mounted module, thereby enabling the head-mounted device to be configured to provide a floating image composed of the second image light beams.

### CROSS-REFERENCE TO RELATED PATENT APPLICATION

This application claims the benefit of priority to the U.S. Provisional Patent Application Ser. No. 63/685,734, filed on Aug. 22, 2024, which application is incorporated herein by reference in its entirety.

### FIELD OF THE DISCLOSURE

The present disclosure relates to a head-mounted device, and more particularly to a head-mounted device for providing floating images.

### BACKGROUND OF THE DISCLOSURE

In the related art, the head-mounted device with display function can only provide a flat image screen for a user to watch, and the flat image screen provided by the head-mounted device cannot be adjusted in three dimensions. Therefore, the head-mounted device provided by the related art still has room for improvement.

### SUMMARY OF THE DISCLOSURE

In response to the above-referenced technical inadequacy, the present disclosure provides a head-mounted device for providing floating images.

In order to solve the above-mentioned problems, one of the technical aspects adopted by the present disclosure is to provide a head-mounted device for providing floating images, which includes a head-mounted module configured to be wearably disposed on a user's head, an image display module configured to be disposed inside the head-mounted module and carried by the head-mounted module, and an optical imaging module configured to be disposed inside the head-mounted module and carried by the head-mounted module. The image display module is configured to provide a plurality of first image beams projected toward a first predetermined direction onto the optical imaging module inside the head-mounted module. The optical imaging module is configured to respectively convert the first image beams provided by the image display module into a plurality of second image beams that are projected toward a second predetermined direction to leave the head-mounted module, thereby enabling the head-mounted device to be configured to provide a floating image composed of the second image beams. The first predetermined direction and the second predetermined direction are different or the same. The second image beams cooperate with each other to form the floating image on a virtual plane under the head-mounted module, thereby enabling the head-mounted device to be configured to provide the floating image for the user to watch.

These and other aspects of the present disclosure will become apparent from the following description of the embodiment taken referring to the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a head-mounted device for providing floating images according to a first embodiment of the present disclosure;

FIG. 2 is a functional block diagram of the head-mounted device for providing floating images according to the first embodiment of the present disclosure;

FIG. 3 is a partial schematic cross-sectional view of the head-mounted device for providing floating images according to the first embodiment of the present disclosure;

FIG. 4 is a schematic side view of an optical imaging module of the head-mounted device for providing floating images according to the first embodiment of the present disclosure;

FIG. 5 is a schematic top view of the head-mounted device for providing floating images using a single optical accessory set according to the first embodiment of the present disclosure;

FIG. 6 is a schematic top view of the head-mounted device for providing floating images using two optical accessory sets according to the first embodiment of the present disclosure;

FIG. 7 is a partial schematic cross-sectional view of the head-mounted device for providing floating images according to a fourth embodiment of the present disclosure (before moving the image display module relative to the optical imaging module through the movable carrier module);

FIG. 8 is a partial schematic cross-sectional view of the head-mounted device for providing floating images according to the fourth embodiment of the present disclosure (after moving the image display module relative to the optical imaging module through the movable carrier module);

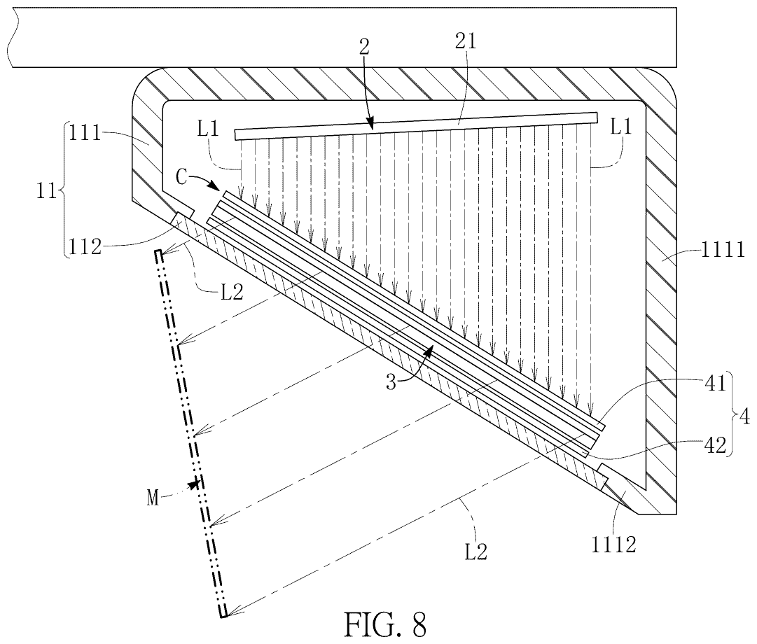

FIG. 9 is a partial schematic cross-sectional view of the head-mounted device for providing floating images according to a third embodiment of the present disclosure; and

FIG. 10 is a partial schematic cross-sectional view of the head-mounted device for providing floating images according to a fourth embodiment of the present disclosure.

### DETAILED DESCRIPTION OF THE EXEMPLARY EMBODIMENTS

### First Embodiment

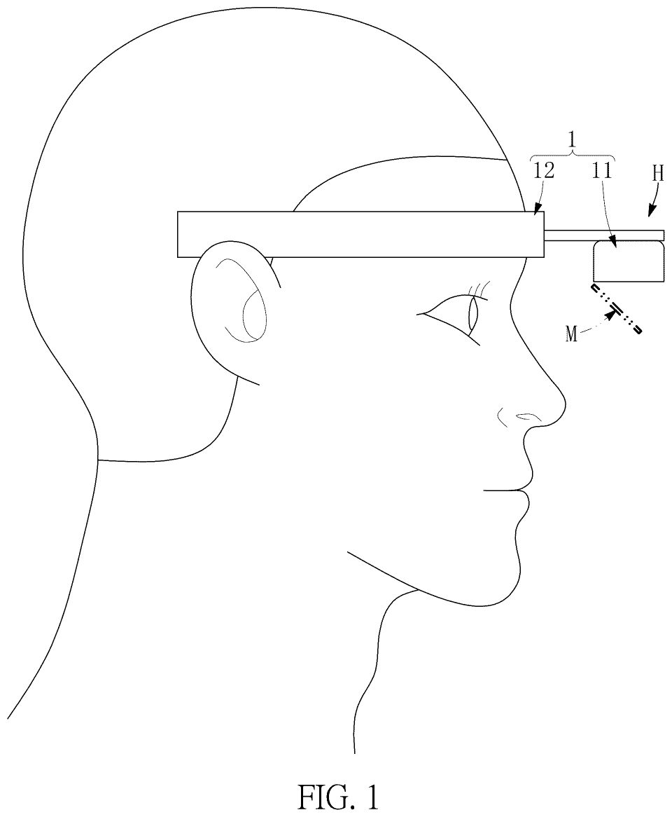

Referring to FIG. 1 to FIG. 6, the first embodiment of the present disclosure provides a head-mounted device H for providing a floating image M, which may at least include a head-mounted module 1, an image display module 2 and an optical imaging module 3, and the image display module 2 and the optical imaging module 3 may cooperate with each other to form a floating projection system.

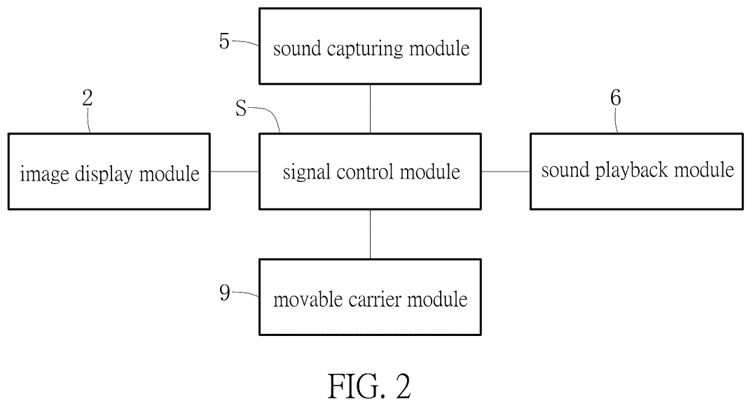

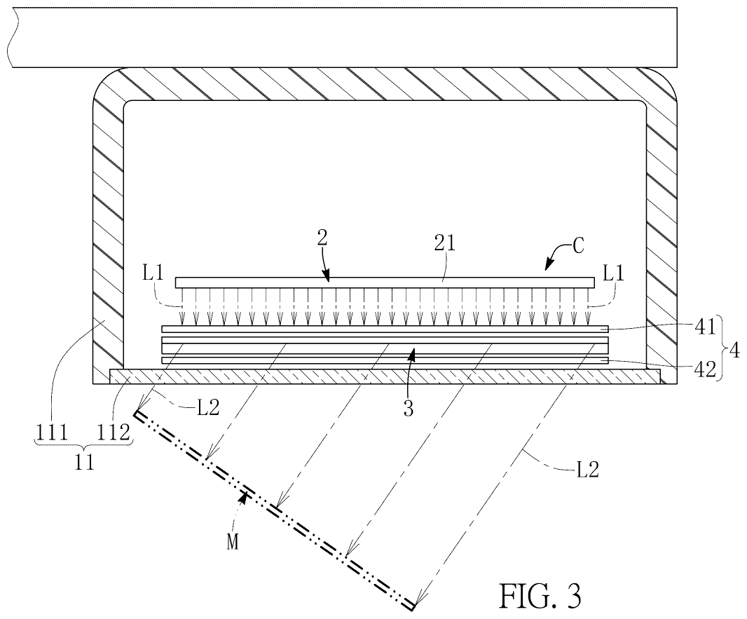

Furthermore, referring to FIG. 1, FIG. 2 and FIG. 3, the head-mounted module 1 may be configured to be wearably disposed on a user's head. For example, the head-mounted module 1 may include a device casing structure 11 and a head-mounted structure 12 (such as a head-mounted accessory) connected to (such as detachably or fixedly connected to) the device casing structure 11. Moreover, the head-mounted structure 12 of the head-mounted module 1 can be configured to carry the device casing structure 11, and the head-mounted structure 12 of the head-mounted module 1 can be configured to be wearably disposed on the user's head. In addition, the device casing structure 11 of the head-mounted module 1 may include an opaque casing 111 and a light-transmitting panel 112 (or a transparent substrate that can provide a transparent window) disposed on the opaque casing 111.

Furthermore, FIG. 1, FIG. 2 and FIG. 3, the image display module 2 can be configured to be disposed inside the head-mounted module 1 and carried by the head-mounted module 1, and the image display module 2 can be electrically connected to a signal control module S (or a signal processing module). In one of the feasible embodiments, the image display module 2 can be configured to provide a plurality of first image beams L1 that can be projected toward a first predetermined direction to the optical imaging module 3 inside the head-mounted module 1 (that is to say, the first image beams L1 can be projected toward the same or different first predetermined directions to the optical imaging module 3). For example, when the image display module 2 can be configured as a direct projection image display module (such as an image display module for directly projecting images that does not require an additional optical focusing lens group), the image display module 2 may include an image display 21 (such as a TFT display, a micro OLED display, a micro LED display, or a mini LED display), and the image display 21 can be configured to provide a plurality of first image light beams L1 that can be projected toward a first predetermined direction to the optical imaging module 3 inside the head-mounted module 1.

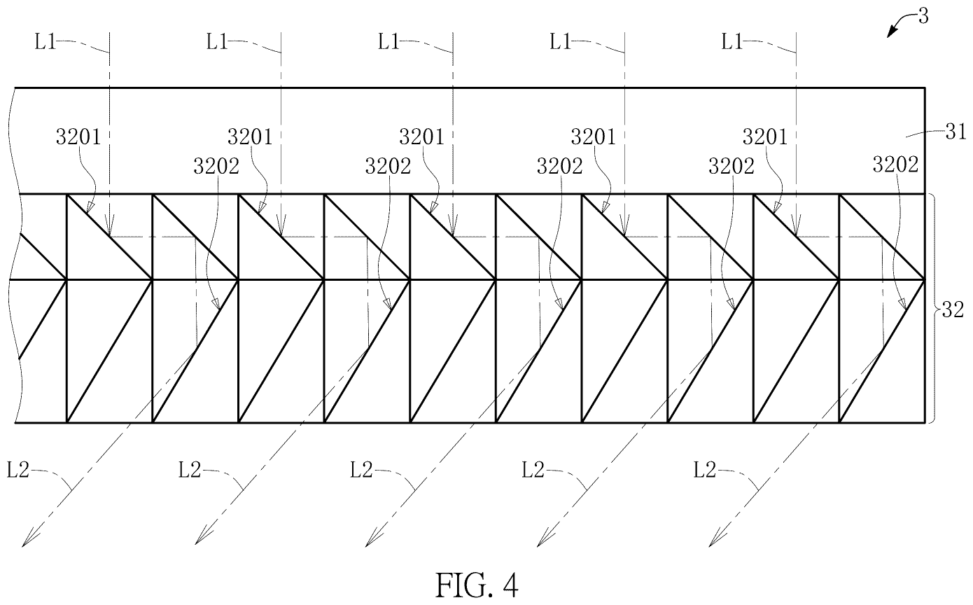

Furthermore, referring to FIG. 1, FIG. 3, and FIG. 4, the optical imaging module 3 can be configured to be disposed inside the head-mounted module 1 and carried by the head-mounted module 1. In one of the feasible embodiments, the optical imaging module 3 can be configured to optically convert (or optically reflect) the first image beams L1 that are provided by the image display module 2 into the second image beams L2 that are projected toward a second predetermined direction to leave the head-mounted module 1 (that is to say, the second image beams L2 can leave the head-mounted module 1 in the same or different second predetermined directions), so that the head-mounted device H can be configured to provide a floating image M composed of the second image beams L2. It is worth noting that the first predetermined direction and the second predetermined direction are two different directions (or the second predetermined direction can be inclined to the first predetermined direction) or two identical directions. For example, the optical imaging module 3 can be configured as a dihedral corner reflector array (DCRA) element. Furthermore, the optical imaging module 3 may include a light-transmitting carrier substrate 31 and an optical imaging assembly 32 (or two optical imaging assemblies stacked on each other) disposed on the light-transmitting carrier substrate 31, and the optical imaging assembly 32 may include a plurality of micro-prism arrays or a plurality of micro-reflector arrays that cooperate with each other. In addition, the optical imaging assembly 32 can be configured to provide a plurality of first reflection surfaces 3201 arranged in parallel to each other and a plurality of second reflection surfaces 3202 arranged in parallel to each other, and each first image beam L1 generated by the image display module 2 can be sequentially reflected by two adjacent first reflection surfaces 3201 and a corresponding second reflection surface 3202 to leave the optical imaging assembly 32 (that is to say, each first image beam L1 generated by the image display module 2 can be sequentially reflected by two adjacent first reflection surfaces 3201, and then reflected by a corresponding second reflection surface 3202, so as to project the second image beams L2 onto a virtual plane located under the head-mounted module 1).

For example, referring to FIG. 1, FIG. 2 and FIG. 3, the head-mounted device H can further include an imaging auxiliary module 4 disposed inside the head-mounted module 1 and carried by the head-mounted module 1, and the imaging auxiliary module 4 can be configured to be used in a floating projection system. In addition, the imaging auxiliary module 4 may include a first optical structure layer 41 disposed between the image display module 2 and the optical imaging module 3 and a second optical structure layer 42 disposed between the optical imaging module 3 and the head-mounted module 1 (or the light-transmitting panel 112). Furthermore, the first optical structure layer 41 may be configured as one or a combination of a first light diffusion film, a first anti-reflection film, a first filter film, a first polarizing film, and a first brightness enhancement film, and the second optical structure layer 42 may be configured as one or a combination of a second light diffusion film, a second anti-reflection film, a second filter film, a second polarizing film, and a second brightness enhancement film. Therefore, the first image beams L1 generated by the image display module 2 may be transmitted to the optical imaging module 3 through the first optical structure layer 41, and the second image beams L2 converted by the optical imaging module 3 may be transmitted to a lower area (i.e., a virtual plane) located under the head-mounted module 1 through the second optical structure layer 42.

For example, as shown in FIG. 1, FIG. 2 and FIG. 3, the head-mounted device H further includes a sound capturing module 5 (such as using a micro sound-receiving chip or a micro microphone) that can be disposed inside the head-mounted module 1 and carried by the head-mounted module 1, and the sound capturing module 5 can be electrically connected to the signal control module S. Furthermore, the sound capturing module 5 can be configured to capture a sound signal provided or generated by the user, so that the user is able to input at least one operation instruction (such as a voice control operation instruction) for controlling the floating image M to the head-mounted device H through the sound signal.

For example, as shown in FIG. 1, FIG. 2 and FIG. 3, the head-mounted device H further includes a sound playback module 6 (such as using a real-time micro sound output chip or a real-time micro speaker) that can be disposed inside the head-mounted module 1 and carried by the head-mounted module 1, and the sound playback module 6 can be electrically connected to the signal control module S. Furthermore, the sound playback module 6 can be configured to transmit a sound signal to the user, so that the user is able to obtain sound information corresponding to the floating image M provided by the head-mounted device H.

For example, as shown in FIG. 1 and FIG. 3, the head-mounted device H may further include a stereoscopic imaging module disposed inside the head-mounted module 1 and carried by the head-mounted module 1, and the stereoscopic imaging module may be configured to be applied in a floating projection system. In addition, the stereoscopic imaging module may include a light-transmitting carrier substrate and a plurality of stereoscopic grating structures disposed on the light-transmitting carrier substrate. It is worth noting that the light-transmitting carrier substrate and the stereoscopic grating structures may be optical components different from each other, or the light-transmitting carrier substrate and the stereoscopic grating structures may also be integrated into a single optical component. Therefore, when the stereoscopic imaging module is disposed under the image display module 2, the stereoscopic grating structures may be configured to convert the first image beams L1 generated by the image display module 2 into a plurality of stereoscopic image beams, so that the floating image M (or a planar floating image) formed by the cooperation of the second image beams L2 may be converted into a stereoscopic floating image.

For example, as shown in FIG. 1, FIG. 2 and FIG. 3, the head-mounted device H may further include a movable carrier module 9 (or an orientation adjustment module) disposed inside the head-mounted module 1 and carried by the head-mounted module 1, and the movable carrier module 9 can be electrically connected to the signal control module S. In addition, the movable carrier module 9 may be configured to carry the image display module 2, and the movable carrier module 9 (such as an XYZR four-axis mobile platform) may include a horizontal position moving unit (such as an X-axis table and a Y-axis table that can move in the horizontal direction), a vertical position moving unit (a Z-axis table that can move in the vertical direction) and a tilt angle moving unit (an R-axis table that can rotate 360 degrees or tilt at a specific angle). In one of the feasible embodiments, the movable carrier module 9 can be configured to drive the image display module 2 to move in an inclined manner relative to the optical imaging module 3, thereby adjusting the inclination angle (or the tilt angle) of the floating image M relative to the optical imaging module 3 (that is to say, the movable carrier module 9 can be configured to adjust the inclination angle of the floating image M relative to the optical imaging module 3 by driving the image display module 2 to move in an inclined manner). In one of the feasible embodiments, the movable carrier module 9 can be configured to drive the image display module 2 to move vertically relative to the optical imaging module 3, thereby adjusting the image area of the floating image M (that is to say, the movable carrier module 9 can be configured to adjust the screen size of the floating image M by driving the image display module 2 to move in a vertical manner).

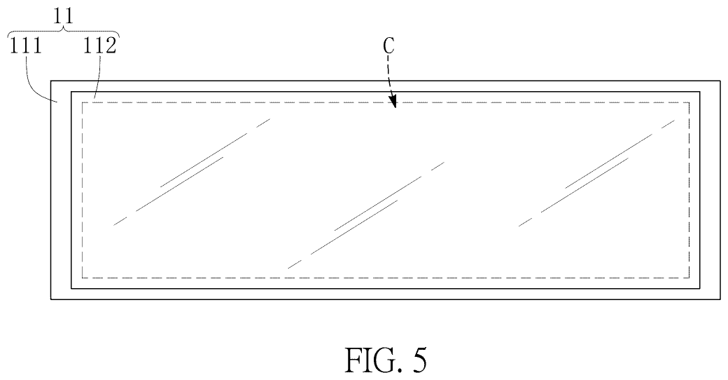

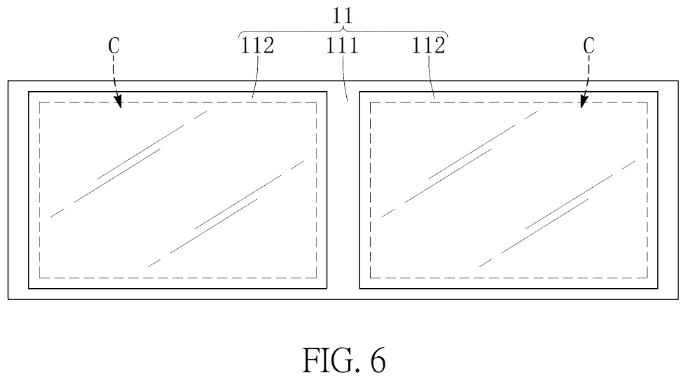

It should be noted that referring to FIG. 2, FIG. 5 and FIG. 6, according to different requirements, the device casing structure 11 of the head-mounted module 1 can use a single opaque casing 111 (as shown in FIG. 5) or two opaque casings 111 (as shown in FIG. 6). In other words, according to different requirements, the head-mounted device H provided by the present disclosure can use a single optical accessory set C (including an image display module 2, an optical imaging module 3, and an imaging auxiliary module 4) or two optical accessory sets C (including an image display module 2, an optical imaging module 3, and an imaging auxiliary module 4). In one feasible embodiment, when the head-mounted device H uses two optical accessory sets C, the head-mounted device H can perform a parallax barrier method (or a left-right image parallax method) through the two optical accessory sets C to provide the user with a stereoscopic image visual effect, so that there is no need to use a stereoscopic grating structure.

Therefore, referring to FIG. 3 and FIG. 4, when the second image light beams L2 generated by the optical conversion of the optical imaging module 3 pass through the light-transmitting panel 112 to leave the head-mounted module 1, the second image light beams L2 can cooperate with each other to form a floating image M on a virtual plane under the head-mounted module 1, thereby allowing the head-mounted device H to be configured to provide the floating image M for the user to watch.

### Second Embodiment

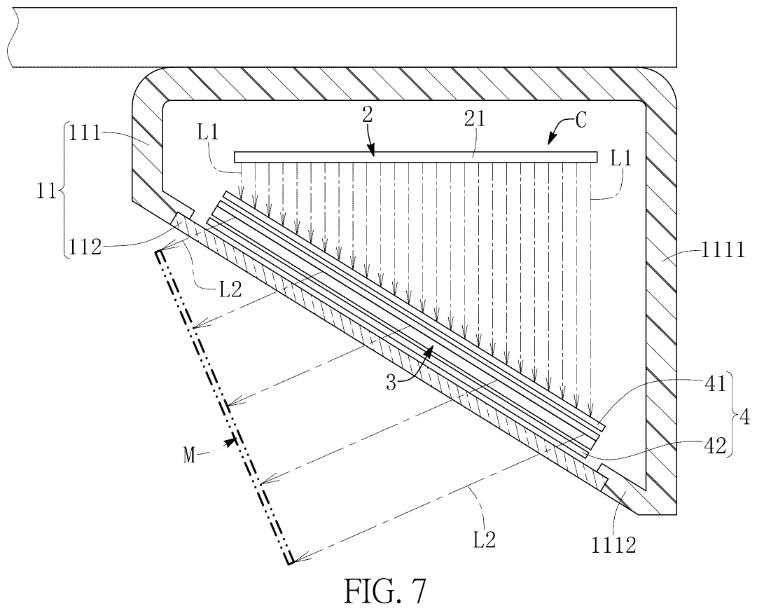

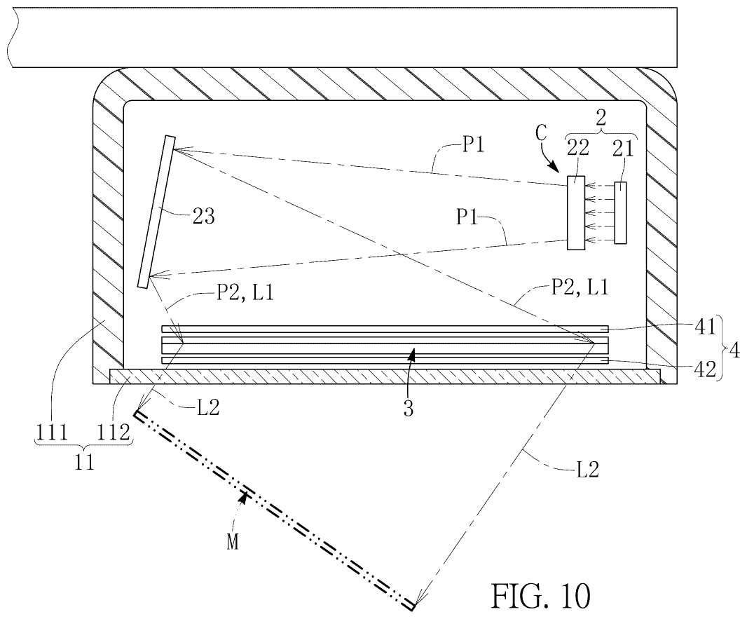

Referring to FIG. 7 and FIG. 10, a second embodiment of the present disclosure provides a head-mounted device H for providing a floating image M. Comparing FIG. 7 with FIG. 1, the main difference between the second embodiment and the first embodiment is as follows: in the second embodiment, the opaque casing 111 of the device casing structure 11 includes a first casing portion 1111 and a second casing portion 1112 extending downwardly from the first casing portion 1111, and the light-transmitting panel 112 is disposed on the second casing portion 1112 to face the user obliquely (in an inclined manner), so that a perpendicular projection of the floating image M provided by the head-mounted device H can directly fall onto the user's eyes.

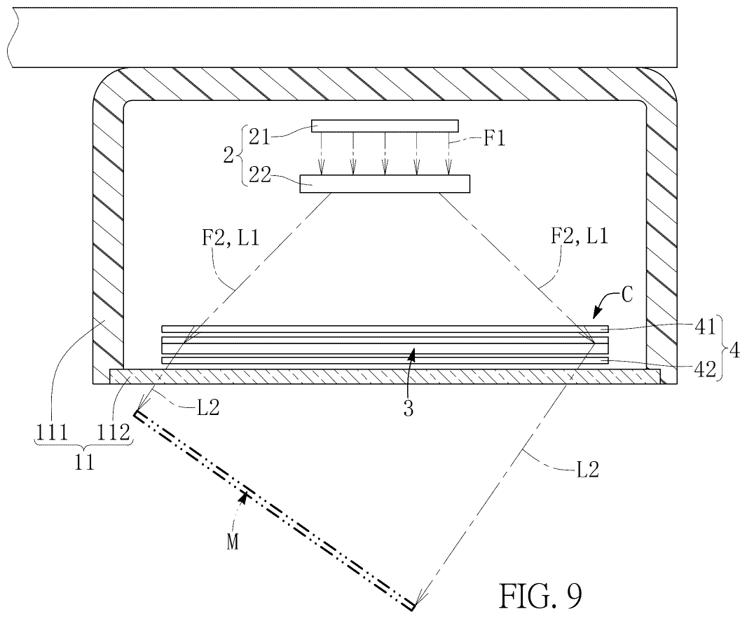

It should be noted that referring to FIG. 7 and FIG. 9, in one of the feasible embodiments, the movable carrier module 9 (referring to FIG. 2) can be configured to drive the image display module 2 to move in an inclined manner relative to the optical imaging module 3, thereby adjusting the inclination angle (or the tilt angle) of the floating image M relative to the optical imaging module 3. In one of the feasible embodiments, the movable carrier module 9 can be configured to drive the image display module 2 to move vertically relative to the optical imaging module 3, thereby adjusting the image area of the floating image M.

### Third Embodiment

Referring to FIG. 9, a third embodiment of the present disclosure provides a head-mounted device H for providing a floating image M, which may at least include a head-mounted module 1, an image display module 2 and an optical imaging module 3. Comparing FIG. 9 with FIG. 3, the main difference between the third embodiment and the first embodiment is as follows: in the third embodiment, when the image display module 2 can be configured as a focusing image display module, the image display module 2 may include an image display 21 and an optical lens group 22 (or an optical focusing lens group) corresponding to the image display 21, and the position and the angle of the image display module 2 can also be further adjusted through a movable carrier module. Furthermore, the image display 21 of the image display module 2 can be configured to generate a plurality of initial image beams F1 (or a plurality of unfocused image beams), and the optical lens group 22 of the image display module 2 can be configured to convert the initial image beams F1 into a plurality of focused image beams F2. For example, the image display 21 can be configured as a liquid crystal display (such as a TFT display) or a light-emitting diode display (such as a micro OLED display, a micro LED display, or a mini LED display).

Therefore, as shown in FIG. 9, when the image display module 2 can be configured as a focusing image display module, the optical imaging module 3 can be configured to convert the focusing image beams F2 (i.e., the first image beams L1) provided by the image display module 2 into the second image beams L2 that are projected toward a second predetermined direction to leave the head-mounted module 1.

### Fourth Embodiment

Referring to FIG. 10, a fourth embodiment of the present disclosure provides a head-mounted device H for providing a floating image M, which may at least include a head-mounted module 1, an image display module 2 and an optical imaging module 3. Comparing FIG. 10 with FIG. 3, the main difference between the fourth embodiment and the first embodiment is as follows: in the fourth embodiment, when the image display module 2 can be configured as a reflective image display module, the image display module 2 may include an image display 21, an optical lens group 22 (or an optical focusing lens group) corresponding to the image display 21, and a light reflecting element 23 corresponding to the image display 21 (or corresponding to the optical lens group 22), and the position and the angle of the image display module 2 can also be further adjusted through a movable carrier module. Furthermore, the image display 21 (or the optical lens group 22) of the image display module 2 can be configured to generate a plurality of projected image beams P1, and the light reflecting element 23 of the image display module 2 can be configured to convert the projected image beams P1 into a plurality of reflected image beams P2. For example, the image display 21 can be configured as a micro liquid crystal display (such as a TFT display) or a micro light-emitting diode display (such as a micro OLED display, a micro LED display or a mini LED display).

Therefore, as shown in FIG. 10, when the image display module 2 can be configured as a reflective image display module, the optical imaging module 3 can be configured to convert the reflected image beams P2 (i.e., the first image beams L1) provided by the image display module 2 into a plurality of second image beams L2 that are projected toward a second predetermined direction to leave the head-mounted module 1.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

What is claimed is:

1. A head-mounted device for providing floating images, comprising:
a head-mounted module configured to be wearably disposed on a user's head;
an image display module configured to be disposed inside the head-mounted module and carried by the head-mounted module; and
an optical imaging module configured to be disposed inside the head-mounted module and carried by the head-mounted module;
wherein the image display module is configured to provide a plurality of first image beams projected toward a first predetermined direction onto the optical imaging module inside the head-mounted module;
wherein the optical imaging module is configured to respectively convert the first image beams provided by the image display module into a plurality of second image beams that are projected toward a second predetermined direction to leave the head-mounted module, thereby enabling the head-mounted device to be configured to provide a floating image composed of the second image beams;
wherein the first predetermined direction and the second predetermined direction are different or the same;
wherein the second image beams cooperate with each other to form the floating image on a virtual plane under the head-mounted module, thereby enabling the head-mounted device to be configured to provide the floating image for the user to watch.

2. The head-mounted device for providing floating images according to claim 1,
wherein the head-mounted device further includes an imaging auxiliary module disposed inside the head-mounted module and carried by the head-mounted module, and the imaging auxiliary module includes a first optical structure layer disposed between the image display module and the optical imaging module, and a second optical structure layer disposed between the optical imaging module and the head-mounted module;
wherein the head-mounted device further includes a sound capturing module disposed inside the head-mounted module and carried by the head-mounted module, and the sound capturing module is configured to capture a sound signal provided by the user, so that the user is able to input at least one operation instruction for controlling the floating image to the head-mounted device through the sound signal;
wherein the head-mounted device further includes a sound playback module disposed inside the head-mounted module and carried by the head-mounted module, and the sound playback module is configured to transmit a sound signal to the user, so that the user is able to obtain sound information corresponding to the floating image provided by the head-mounted device;
wherein the head-mounted device further includes a movable carrier module disposed inside the head-mounted module and carried by the head-mounted module, and the movable carrier module is configured to carry the image display module;
wherein the movable carrier module is configured to drive the image display module to move tiltedly relative to the optical imaging module, thereby adjusting a tilt angle of the floating image relative to the optical imaging module; and
wherein the movable carrier module is configured to drive the image display module to move vertically relative to the optical imaging module, thereby adjusting an image area of the floating image.

3. The head-mounted device for providing floating images according to claim 1,
wherein the head-mounted module includes a device casing structure and a head-mounted structure connected to the device casing structure;
wherein the device casing structure of the head-mounted module includes an opaque casing and a light-transmitting panel disposed on the opaque casing, and the second image light beams pass through the light-transmitting panel to leave the head-mounted module;
wherein the optical imaging module is configured as a dihedral corner reflector array element;
wherein the optical imaging module includes a light-transmitting carrier substrate and an optical imaging assembly disposed on the light-transmitting carrier substrate, and the optical imaging assembly includes a plurality of micro-prism arrays or a plurality of micro-reflector arrays that cooperate with each other; and
wherein the optical imaging assembly is configured to provide a plurality of first reflection surfaces arranged in parallel to each other and a plurality of second reflection surfaces arranged in parallel to each other, and each of the first image light beams generated by the image display module is sequentially reflected by two adjacent ones of the first reflection surfaces and a corresponding one of the second reflection surfaces so as to leave the optical imaging assembly.

4. The head-mounted device for providing floating images according to claim 1, wherein the image display module is configured as a direct projection image display module.

5. The head-mounted device for providing floating images according to claim 1, wherein the image display module is configured as a focusing image display module.

6. The head-mounted device for providing floating images according to claim 1, wherein the image display module is configured as a reflective image display module.

7. The head-mounted device for providing floating images according to claim 1,
wherein the head-mounted module includes a device casing structure and a head-mounted structure connected to the device casing structure;
wherein the device casing structure of the head-mounted module includes an opaque casing and a light-transmitting panel disposed on the opaque casing, and the second image light beams pass through the light-transmitting panel to leave the head-mounted module; and
wherein the opaque casing of the device casing structure includes a first casing portion and a second casing portion extending downwardly from the first casing portion, and the light-transmitting panel is disposed on the second casing portion to obliquely face the user, so that a perpendicular projection of the floating image provided by the head-mounted device directly falls onto two eyes of the user.

8. The head-mounted device for providing floating images according to claim 1,
wherein the head-mounted device further includes a sound capturing module disposed inside the head-mounted module and carried by the head-mounted module, and the sound capturing module is configured to capture a sound signal provided by the user, so that the user is able to input at least one operation instruction for controlling the floating image to the head-mounted device through the sound signal; and
wherein the head-mounted device further includes a sound playback module disposed inside the head-mounted module and carried by the head-mounted module, and the sound playback module is configured to transmit a sound signal to the user, so that the user is able to obtain sound information corresponding to the floating image provided by the head-mounted device.

9. The head-mounted device for providing floating images according to claim 1, wherein the head-mounted device further includes a movable carrier module disposed inside the head-mounted module and carried by the head-mounted module, and the movable carrier module is configured to carry the image display module.

10. The head-mounted device for providing floating images according to claim 9, wherein the movable carrier module is configured to drive the image display module to move tiltedly relative to the optical imaging module, thereby adjusting a tilt angle of the floating image relative to the optical imaging module.

11. The head-mounted device for providing floating images according to claim 9, wherein the movable carrier module is configured to drive the image display module to move vertically relative to the optical imaging module, thereby adjusting an image area of the floating image.
